(19) United States
(12) Patent Application Publication
(10) Pub. No.: US 2017/0199979 A1
(43) Pub. Date: Jul. 13, 2017

(54) METHOD AND SYSTEM OF RADIATION PROFILING

(71) Applicant: Bruce REINER, Berlin, MD (US)

(72) Inventor: Bruce REINER, Berlin, MD (US)

(21) Appl. No.: 15/403,375

(22) Filed: Jan. 11, 2017

Related U.S. Application Data
(60) Provisional application No. 62/277,190, filed on Jan. 11, 2016.

(51) Int. Cl. G06F 19/00

(52) U.S. Cl. CPC G06F 19/3431; G06F 19/324

(57) ABSTRACT

The present invention relates to a method and system of risk assessment, by profiling individuals to quantify radiation or agent sensitivity and risk on both organ specific and collective whole body levels, using data including demographic information, medical records, and data from embedded, mobile or fixed sensors. The risk assessment may include analytics on genetic make-up, family history, occupational history, environmental history, medical history, physical attributes, age/gender, socio-economic status, education, and health awareness. When the data is combined with actual and estimates of radiation or agent dose exposures in a geographic environment, the net result is the creation of a risk score which determines the predicted risk an individual has for developing induced mutation, organ injury, and/or cancer.

The present invention claims priority from U.S. Provisional Patent Application No. 62/277,190, filed Jan. 11, 2016, the contents of which are herein incorporated by reference in their entirety.

### BACKGROUND OF THE INVENTION

1. Field of the Invention

The present invention relates to a method and system of determining radiation risk which takes into account inter- and intra-variability in radiation sensitivity within individuals, and which improves the accuracy and completeness of radiation exposure measures.

2. Description of the Related Art

Most existing applications which record, monitor, and analyze radiation data in healthcare do so in a relatively inflexible manner; treating individual participants as relatively fixed and uniform entities, once age has been accounted for. In medical imaging applications, radiation dose estimates are largely calculated in a standardized fashion using acquisition parameters, which do not take into account a wide array of patient-specific variables which may ultimately affect the physiologic and genetic impact of radiation on long term health. These ‘static” radiation dose calculations are subsequently combined to yield a cumulative radiation dose; which can be correlated with published statistical data (largely based upon Japanese atomic bomb survivors) to determine a relative risk for radiation induced carcinogenesis.

But apart from carcinogenesis, there are a number of other iatrogenic complications related to radiation exposure, including (but not limited to) skin burns, hair loss, sterility, cataracts, gastrointestinal complications (nausea, vomiting, diarrhea, anorexia), growth retardation, in utero congenital anomalies, and vasculitis. These need to be considered when attempting to calculate radiation risk, which is in actuality a dynamic and highly variable parameter.

A large number of factors contribute to the development of these complications, which can affect individuals in different ways. While the primary focus on radiation exposure to date is largely focused upon medical and catastrophic radiation sources, a large number of alternative radiation sources are experienced in everyday life, which contributes to overall radiation risk. To date, these non-medical radiation exposures are frequently ignored, which can significantly underestimate and devalue the clinical reliability of these radiation risk calculations.

In addition to improving the accuracy and completeness of radiation exposure measures, a truly accurate methodology for determining radiation risk should also take into account inter- and intra-variability in radiation sensitivity within individuals.

### SUMMARY OF THE INVENTION

The present invention relates to a method and system of determining radiation risk which takes into account inter- and intra-variability in radiation sensitivity within individuals, and which improves the accuracy and completeness of radiation exposure measures.

These variables can be quantified by creating user-specific profiles which take into account a wide array of factors, which are independent from the actual radiation dose estimates. These factors include: individual and cumulative radiation dose estimates, time interval over which the dose is delivered, the overall state of health, the organ systems and tissue volume exposed, age, physical attributes (e.g., height, weight, body mass index), type of radiation, genetic susceptibility, immune status, health awareness, education, family history, medical and surgical history, social history (e.g., smoking, alcohol, recreational drug use), and medications. In fact, this same principle of creating user-specific profile can be applied to a myriad of other exposure agents in addition, to radiation, such as allergens (e.g., pollen), chemicals (e.g., chlorine), gases (e.g., carbon monoxide), biologic pathogens (e.g., anthrax), hydrocarbons (e.g., gasoline), solvents (e.g., toluene), carcinogens (e.g., asbestos), and minerals (e.g., silicates).

The combination of complete and accurate radiation dose estimate calculations and individual specific Radiation Profiles can be used to create a “dynamic profile-adjusted radiation risk score”, which can be used to proactively assist in lifestyle, medical, occupational, and environmental decision making; with the goal of reducing radiation-induced complications.

With the advent of the electronic medical record, personalized medicine, and increased requirements for reporting radiation data, the technology infrastructure exists for more accurate and definitive radiation dose tracking and analysis. The ability to customize radiation dose measurement, documentation, and analysis both within medicine and everyday life provides an opportunity to revolutionize radiation safety and lead to the creation of new technologies, data mining techniques, and interventional strategies. These same principles of using scientific methods to measure, record, document, and analyze radiation in conjunction with the individual's profile to calculate dynamic risk scores can also be applied to the above wide array of other types of exposure agents causing health risks. These dynamic radiation data and risk scores can be used prospectively to assist in medical decision making (e.g., diagnosis or treatment optimization) or protocol optimization (e.g., modification of medical imaging exam acquisition parameters) as a form of customizable decision support. The ultimate goal is to create objective and customized cost benefit analyses (relating to radiation exposure) at the point of care, with the goal of optimizing clinical outcomes through enhanced medical diagnosis and treatment and reduced risk of iatrogenic injury caused by radiation.

In one embodiment, a method of providing a risk assessment, includes: receiving data inputted on an individual, the data including at least a medical history of the individual, and saving the data in at least one database of a computer system; creating a user-specific profile, which classifies the individual into a category commensurate with risk of injury to one of radiation exposure or exposure to at least one of an organic, a pathogenic, or a noxious agent or stimuli; wherein the user-specific profile includes at least one category of classification of the individual based on user compliance with medical instructions and educational status; receiving data from at least one sensor disposed within or on the individual, or disposed in a geographic location, and saving the sensor data in the at least one database; presenting to the individual, on a display of the computer system, a customized snapshot of data from at least the medical history, the user-specific profile, and the at least one sensor; performing analytics using the data from at least the medical history, the user-specific profile, and the at least one sensor, to assess risk to the individual; and providing the individual with at least one option for an intervention to mitigate the risk.

In one embodiment, the medical history includes at least one of an age of a patient, past radiation exposure or agent exposure to the patient, patient genetic make-up, or genetic analysis of a specific pathology of the patient, are incorporated into the user-specific profile, and are used in the analytics to predict relative medical risk or optimize medical treatment planning.

In one embodiment, the method includes updating the user-specific profile based upon prospective data analysis and user-provided feedback.

In one embodiment, the method includes collecting and monitoring data from the at least sensor, wherein the at least one sensor records data from a radiation source including at least one of occupational, environmental, medical, technologic, criminal, or catastrophic sources of radiation.

In one embodiment, the agent exposure includes exposure to environmental allergens, chemicals, gases, biologic agents, pharmaceuticals, hydrocarbons, industrial solvents, carcinogens, or minerals.

In one embodiment, the combined retrospective and prospective data obtained from at least the medical history, the user-specific profile, and the at least one sensor, are used for the analytics to calculate the risk, and to create a total exposure index and weighted exposure index; wherein the total exposure index is a cumulative total of all exposure measurements, which is independent of user-specific and context-specific risk factors; and wherein the weighted exposure index is a measure which combines a totality of exposure measurements with individual risk factors, in order to mathematically predict relative risk over different durations of time and different exposure intensities and distributions.

In one embodiment, the predicted relative risk for the patient is used to modify patient radiation dose, timing, and duration to reduce iatrogenic complications, in accordance with a radiation user-specific profile of the patient.

In one embodiment, the radiation user-specific profile is directed to at least one of a specific individual, an organ system, or a type of pathology.

In one embodiment, the radiation user-specific profile is used to identify other patients with similar radiation user-specific profiles; wherein data from the radiation user-specific profile is analyzed with the radiation user-specific profiles of the other patients, to create evidence-based medicine best clinical practice guidelines.

In one embodiment, the at least one sensor is one of directly embedded into the end-user's body, or into a wearable device of a user, disposed in a stationary measuring device physically positioned in a geographic location, or in a mobile device that moves in a geographic area; and wherein continuous data is obtained in real-time from the at least one sensor.

In one embodiment, the at least one sensor is a radon sensor, a carbon monoxide sensor, a wind sensor, a radiation sensor, a carcinogenic sensor, a virus or bacterial agent sensor, a GPS sensor, or a heat sensor.

In one embodiment, the real-time continuous data is integrated with a geographic location analysis, to create a three-dimensional (3D) map which plots a concentration and distribution of radiation or agent over time; and wherein an analysis of said risk exposure specific to the individual is performed, including continuous analysis of data specific to the radiation or agent and the geographic location.

In one embodiment, the method includes: using the GPS sensor to create a vector analysis of migration, perform customizable context and user-specific risk analyses based upon user-specific profiles, the vector analysis including a least one of providing a nearby safe area, providing directions to the nearby safe area, providing feedback which tracks ongoing measurements as the individual travels through said geographic location, and providing heat maps demonstrating differential levels and associated risk over the geographic location.

In one embodiment, the feedback tracking includes at least one of voice, text or email, including color-coding of navigation routes through the geographic location.

In one embodiment, the at least one sensor is a mobile sensor which is one of a self-propelled motorized device, a drone, a tandem device, a projectile or a propulsion device.

In one embodiment, the method includes: measuring the agent using the at least one sensor, the agent which is specific to the individual and specific to the geographic location; combining data measurements from the individual with data recorded by other individuals traveling within the geographic location, and data recorded by sensors disposed in the geographic location; analyzing the combined data measurements to produce a real-time vector analysis of each agent, which when combined with external weather conditions including, heat and wind, produces dynamic actual and predictive exposure measurements; correlating a changing position of the individual and analytics of said user-specific profile, to create a customizable continuous cumulative risk score which can be derived and delivered to the individual in accordance with predetermined communication and educational preferences.

In one embodiment, the continuous cumulative risk score can be classified in accordance with the agent, the organ system, the type of pathology, or the geographic location.

In one embodiment, the method includes: correlating data obtained from the at least one sensor with healthcare data from local healthcare facilities to predict transmission rates or pathogenicity of the agent, and to provide interventional strategies for containment and treatment.

In one embodiment, the method includes: correlating data from the sensors disposed in the geographic location within close proximity to one another, to ensure that data measurements recorded by the sensors are consistent with one another over time.

In one embodiment, when data changes from the at least one sensor, or the risk assessment exceeds a predetermined threshold or category, at least one of an automated alert or prompt, which requires review and acknowledgement, is sent to at least one of the individual, healthcare providers, law enforcement agencies, or public safety providers.

In one embodiment, when at least one of the review and acknowledgement or intervention commensurate with a level of priority, are not completed within a predefined time, an escalation pathway is engaged which requires at least one of a designated person to formally acknowledge receipt, or to initiate a safety consultation and formal review by specialists.

In one embodiment, the automated alert includes options for improving compliance by the individual, and the automated alert is customized based upon the user-specific profile and the risk assessment specific to the agent being monitored.

In one embodiment, the real-time exposure data received from the at least one sensor, and projections based upon magnitude, location, and directionality can be customized in accordance with the user-specific profile to provide up-to-minute risk assessment.

In one embodiment, the analytics are customized, and the customized analytics are accompanied by targeted educational information guided by a customized user-specific profile.

In one embodiment, the analytics and any data review or requests by third parties, are recorded in the database, including information on at least one of specific data reviewed, time spent on each item, requested analytics, consultation requests, or educational programs utilized.

In one embodiment, when the risk assessment indicates increased radiation risk to the individual, all elective requests for medical examinations or procedures with ionizing radiation are analyzed for safety of the individual.

In one embodiment, the review of the ionizing radiation includes analysis of a radiation profile of an ordering clinician, protocols employed for the medical examinations or procedures, a radiation profile of a technologist performing the medical examinations or procedures, and a technology which will be used.

In one embodiment, when one of a provider, protocol, or technology exceeds a predetermined radiation safety baseline level, an automated alert is sent to the individual and to authorized persons, the alert which includes alternative options of providers, technologies, or protocols which have radiation safety profiles which mitigate the risk to the individual.

In one embodiment, the automated alert contains data including an identification of the patient, the user-specific profile information of the patient, the agent of interest, recorded data measurements of the agents, patient-specific analytics related to current, historic, and future risk exposure predictions, and the continuous cumulative risk scores.

In one embodiment, when a medical risk of the individual is mitigated, authorized persons are notified by electronic means, and a medical risk assessment is recalculated and forwarded to the authorized persons.

In one embodiment, the method further includes: using the user-specific profile data and the analytics to predict future patterns and actions, in accordance with dynamic data measurements and trending analyses, including predicting future radiation dose levels, geographic distribution of radiation, and morbidity or mortality in accordance with local population radiation profiles, and strategies for containment, intervention, and medical treatment, to optimize disaster recovery efforts.

In one embodiment, a quality assurance or quality control program provides routine testing, calibration, and monitoring of data being recorded with the at least one sensor.

In one embodiment, the method includes: preparing a checklist to facilitate improved compliance with guidelines and standards by providers, while also promoting customized educational and decision support tools for the providers; and presenting the checklist to a provider when a specific task is performed or when data recorded in the database is incorrect or insufficient; wherein the checklist is customized to the provider and usage patterns of the provider.

In one embodiment, a patient checklist is provided to assist in patient education, continuous data collection, and interventional strategies for enhanced radiation safety.

In one embodiment, rewards and incentives are integrated into usage of the checklist usage to encourage improved provider checklist compliance and overall performance.

In one embodiment, technology performance data is made accessible to the public in order to incentivize technology producers to improve performance and reliability of the technology used.

In one embodiment, the analytics include medical decision support, to facilitate improved healthcare economics; wherein healthcare economics includes a reimbursement of technical and professional costs by payers based on radiation safety measures and compliance with best practice guidelines; and wherein patient insurance premiums are correlated with patients' participation in radiation safety, education, and interventional efforts.

In one embodiment, the analytics on the patient include cumulative medical radiation exposure, radiation risk, confounding variables affecting radiation risk, dose estimates associated with the study being ordered, and alternative strategies for dose reduction.

In one embodiment, a system which provides a risk assessment, includes: at least one sensor disposed within or on an individual, or disposed in a geographic location, which records data in a database of a computer system; at least one memory which contains at least one program which includes the steps of: receiving data inputted on an individual, the data including at least a medical history of the individual, and saving the data in at least one database of a computer system; creating a user-specific profile, which classifies the individual into a category commensurate with risk of injury to one of radiation exposure or exposure to at least one of an organic, a pathogenic, or a noxious agent or stimuli; wherein said user-specific profile includes at least one category of classification of the individual based on user compliance with medical instructions and educational status; receiving data from at least one sensor and saving the sensor data in the at least one database; presenting to the individual, on a display of the computer system, a customized snapshot of data from at least the medical history, the user-specific profile, and the at least one sensor; performing analytics using the data from at least the medical history, the user-specific profile, and the at least one sensor, to assess risk to the individual; and providing the individual with at least one option for an intervention to mitigate the risk; and at least one processor for executing the program.

In one embodiment, a non-transitory computer readable medium whose contents cause a computer system to provide a risk assessment, including: receiving data inputted on an individual, the data including at least a medical history of the individual, and saving the data in at least one database of a computer system; creating a user-specific profile, which classifies the individual into a category commensurate with risk of injury to one of radiation exposure or exposure to at least one of an organic, a pathogenic, or a noxious agent or stimuli; wherein the user-specific profile includes at least one category of classification of the individual based on user compliance with medical instructions and educational status; receiving data from at least one sensor disposed within or on the individual, or disposed in a geographic location, and saving the sensor data in the at least one database; presenting to the individual, on a display of the computer system, a customized snapshot of data from at least said medical history, the user-specific profile, and the at least one sensor; performing analytics using the data from at least the medical history, the user-specific profile, and the at least one sensor, to assess risk to the individual; and providing the individual with at least one option for an intervention to mitigate the risk.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 shows a schematic diagram of a computer system and environment, according to one embodiment consistent with the present invention.

FIGS. 2A and 2B are a flow chart showing steps in assessment of risk, according to one embodiment consistent with the present invention.

### DESCRIPTION OF THE INVENTION

In prior U.S. patent application Ser. No. 11/976,518, filed Oct. 25, 2007, and U.S. patent application Ser. No. 13/064,522 filed Mar. 30, 2011 (now issued as U.S. Pat. No. 8,412,544), and both herein incorporated by reference in their entirety, a detailed methodology was described for calculating and analyzing radiation doses in context and user-specific fashions, while also determining the relationship between radiation dose and image quality in medical imaging applications. The inventions disclosed therein, included creating an objective data-driven method for introducing accountability in radiation safety and medical image quality, while taking into account the individual and collective contributions individual stakeholders and technologies play in the overall process.

The present invention incorporates those concepts by reference herein, but further relates to a method and system of risk assessment, by profiling individuals to quantify radiation or agent sensitivity and risk on both organ specific and collective whole body levels, using medical records, and data from embedded, mobile or fixed sensors. The risk assessment includes analytics on genetic make-up, family history, occupational history, environmental history, medical history, physical attributes, age/gender, socio-economic status, education, and health awareness. When the data is combined with actual and estimates of radiation or agent dose exposures throughout a given patient's life, the net result is the creation of a risk score which determines the predicted risk an individual has for developing induced mutation, organ injury, and/or cancer. The calculated risk score can in turn be correlated with real and observed healthcare data in accordance with patient profile and genetic testing to provide iterative feedback and refinement to the score calculation.

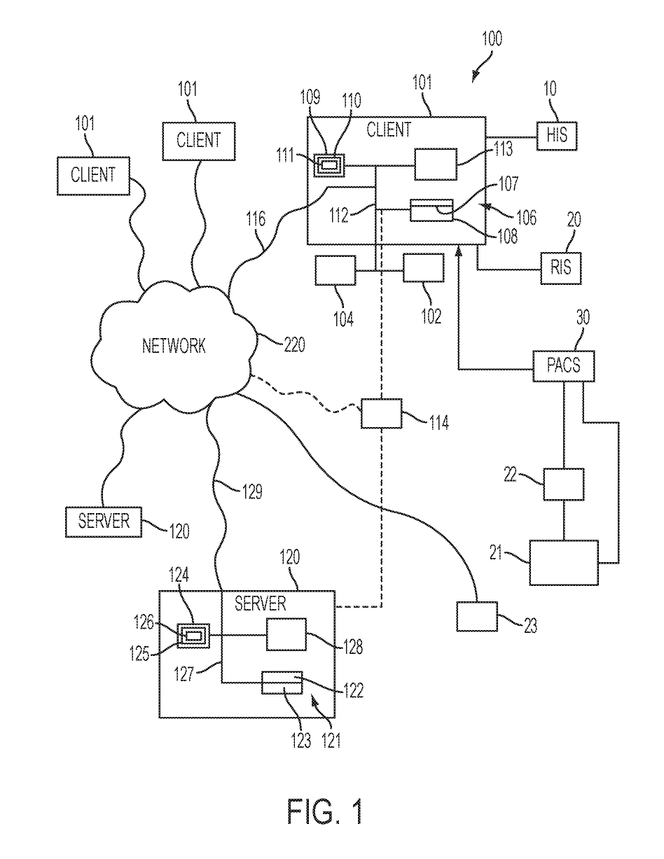

According to one embodiment of the invention illustrated in FIG. 1, medical applications may be implemented using the system 100. The system 100 is designed to interface with existing information systems such as a Hospital Information System (HIS) 10, a Radiology Information System (RIS) 20, a radiographic device 21, and/or other information systems that may access a computed radiography (CR) cassette or direct radiography (DR) system, a CR/DR plate reader 22, a Picture Archiving and Communication System (PACS) 30, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the system 100 of the present invention and the information systems, such as the HIS 10, RIS 20, CR/DR plate reader 22, and PACS 30, etc., may be enabled to allow the system 100 to retrieve and/or provide information from/to these systems. According to one embodiment of the invention, bi-directional communication between the system 100 of the present invention and the information systems allows the system 100 to update information that is stored on the information systems. According to one embodiment of the invention, bi-directional communication between the system 100 of the present invention and the information systems allows the system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), tablet, smart phone, or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the client computer 101. According to one embodiment of the invention, users may input commands to a user interface through a programmable stylus, keyboard, mouse, speech processing device, laser pointer, touch screen, or other input device 104.

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus may be used to draw symbols onto the image and may be used to accomplish other tasks that are intrinsic to the image display, navigation, interpretation, and reporting processes. The multi-functional programmable stylus may provide superior functionality compared to traditional computer keyboard or mouse input devices. According to one embodiment of the invention, the multi-functional programmable stylus also may provide superior functionality within the PACS and Electronic Medical Report (EMR).

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the image display device 102 may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles/glasses may be used as a graphical display to provide end users with the ability to review images. According to another embodiment of the invention, the high resolution goggles may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, the system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines.

According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the systems corresponding to the HIS 10, the RIS 20, the radiographic device 21, the CR/DR reader 22, and the PACS 30 (if separate) are shown as directly coupled to the client computer 101, it is known that these systems may be indirectly coupled to the client over a LAN, WAN, the Internet, and/or other network via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, or other forms of ROM or RAM either currently known or later developed. Further, although specific components of the system have been described, one skilled in the art will appreciate that the system suitable for use with the methods and systems of the present invention may contain additional or different components.

The present invention includes a number of different components, applications, and derived analytics which can be used for predicting healthcare risk for a number of potentially pathologic exposure agents. The description of the overall invention and its unique characteristics are described below.

In one embodiment, the program 110 of the system 100 creates user-specific radiation profiles, which classifies individuals into categories commensurate with risk of radiation-induced injury, predicted exposure rates, concern, compliance, and educational status.

These user-specific radiation profiles are dynamic by nature and are constantly updated by the program 110 based upon prospective data analysis and user-provided feedback (discussed further below). This effectively allows individual users to migrate from one radiation profile to another over time.

A number of radiation sources contribute to this combined profiling, dose tracking, analysis, and intervention including (but not limited to) occupational, environmental, medical, technologic, criminal, and catastrophic sources of radiation.

In addition to radiation, comparable methods can be used to create user-specific profiles, tracking, analytic, and interventional tools for other organic, pathogenic, and noxious substances/stimuli including (but not limited to) environmental allergens (e.g., pollen), chemicals (e.g., chlorine), gases (e.g., carbon monoxide, radon), biologic agents (e.g., anthrax), hydrocarbons (e.g., gasoline), industrial solvents (e.g., toluene), carcinogens (e.g., asbestos), and minerals (e.g., silicates).

In addition to prospective data collection and monitoring, the present invention includes retrospective data estimates, commensurate with the availability and reliability of historic data sources. When retrospective data is used in calculations and analyses, ranges will be provided by the program 110 to provide for pre-defined standards of deviation in accordance with the reliability and predictability of the data and methods used.

The combined retrospective (estimated) and prospective (actual) data used for calculations and analyses will ultimately be used by the program 110 to create a “total exposure index” and “weighted exposure index”. The total exposure index is a cumulative total of all exposure measurements, which is independent of user and context-specific risk factors. The weighted exposure index is a measure which combines the totality of exposure measurements with individual risk factors, in order to mathematically predict relative disease risk over time.

These derived predicted risk measures are extrapolated by the program 110 over different durations of time (e.g., different life expectancy ranges) and over different exposure intensities and distributions. As an example, an individual who has experienced a high intensity and/or prolonged exposure over a recent time interval (e.g., most recent 6 months) could have different weighted exposure indices calculated by the program 110 in accordance with future exposures at different intensity and/or duration. This provides an educational resource to guide lifestyle and occupational changes commensurate with individual risk adversity.

The program 110 of the present invention uses the patient's age, past exposure, medical history, and genetic make-up to predict risk assessment, and is a valuable tool for decision support. As an example, if a patient has newly diagnosed lung cancer and is undergoing treatment planning, the option and optimal protocol for radiation therapy will be directly impacted by these factors. Using simulation models run by the program 110, the radiation oncologist can modify radiation dose, timing, and duration in accordance with the patient's radiation profile and predicted risk for radiating induced iatrogenic complications (e.g., radiation carcinogenesis, pulmonary fibrosis).

In addition to an individual's genetic composition (i.e., genomic and proteomic analysis), genetic analysis of a specific pathology (e.g., lung cancer) can also be incorporated by the program 110 into the Radiation Profile, which in turn is used by the program 110 to optimize medical treatment planning. In the example of a newly diagnosed lung cancer, radiation sensitivity of the tumor can be determined through genetic analysis of the tumor (with tissue obtained by biopsy), which in turn is used to optimize treatment planning. Treatment planning can also combine a tumor's in vivo response to various medical agents (e.g., chemotherapy) and hormonal markers. In essence, this is an example of how the present invention can be applied to create Radiation Profiles of individual organ systems (e.g., liver, lung) or disease processes (e.g., small cell lung cancer).

Based upon these applications, the program 110 of the present invention creates specific Radiation Profiles for individual persons (e.g., patients), organ systems, or types of pathology. The data from these Radiation Profile databases 113, 114 can be co-mingled and analyzed (i.e., meta-analysis) to create evidence-based medicine (EBM) best clinical practice guidelines. These practice guidelines allow one to take into account phenotypic, historic, and genetic attributes of both the individual patient and disease being treated, in order that the program 110 can devise an optimized treatment protocol.

Using the prior example of newly diagnosed lung cancer, the program's 110 analysis of the individual cancer's Radiation profile, determined the radiation sensitivity of the tumor, with and without adjuvant chemotherapy. At the same time, the individual patient's Radiation Profile provided both total and weighted exposure indices, taking into account specific attributes of the patient, along with their exposure history. If these data were then correlated by the program 110 with comprehensive data from centralized Radiation Profile databases 113, 114, one could, through data mining and statistical analysis, identify other patients and lung cancers with similar Radiation Profiles and leverage the outcome data from these patients to determine best practice (i.e., optimal treatment planning) for the current patient of interest.

This latter example illustrates one of the most important benefits which can be derived from the Radiation Profile data, and that is the ability of the program 110 to use standardized data (e.g., exposure, medical, genetic, pharmaceutical, etc.) to create centralized Radiation Profile databases which provide the ability to perform meta-analysis for research, education, outcomes analysis, decision support, predictive analytics, and new technology/product development. One can envision the time where computer simulation and predictive modeling can be used to develop new treatment protocols, interventional strategies, and disaster planning in accordance with longitudinal data from these databases.

The arena of disaster planning is of particular importance to the present invention, for it provides critical meta-data related to potentially lethal exposures to radiation, biologic agents, and gases. In the event that of either a man-made (e.g., terrorist attack) or natural disaster occurred which resulted in high levels of pathologic exposures, the longitudinal data could be used for detection, quarantining, treatment planning, and long-term intervention. To date, most projections regarding radiation-induced carcinogenesis are based on relatively archaic data from Japanese atomic bomb survivors. The more comprehensive and reliable data obtained by the Radiation Profile program 110 would provide the ability to perform more detailed and arguably accurate analysis of radiation risk and clinical outcomes.

Up to this point, the descriptions of the present invention have largely centered on the data aggregated by the program 110, which is an essential source for the Radiation Profile database. In addition to this aggregated data (which consists of intermittent data points derived from specific events (e.g., medical imaging exam)), continuous data is also an integral part of the Radiation Profile program 110. The ability of the program 110 to utilize data in aggregated, continuous, or combined forms is an important feature of the invention.

Continuous data relies on the ability of the program 110 to continuously record data related to a particular entity (e.g., radiation, biologic pathogens, toxins), enter these into a series of databases 113, 114 (e.g., individual end-user, local, regional, national), and analyze the data on both individual and group bases. This continuous data can be performed by the program 110 on a user-specific basis (i.e., mobile) or geographic (i.e., fixed) basis.

User-specific monitoring and data gathering involves the incorporation of entity-specific monitors in the form of sensors 23 into an embodiment of the individual end-user. This can take the form of either directly embedding the sensor 23 into the end-user's body (e.g., subcutaneous implant), or into a wearable device (e.g., watch, jewelry, clothing). In either case, the sensor 23 would be intimately tied to the movements and location of the individual end-user, thereby continuously recording exposure to the agent of interest in a real-time and continuous fashion.

This continuous data monitoring tied to the individual end-user can be integrated by the program 110 with continuous location analysis (e.g., GPS, Wi-Fi), with the goal of the program 110 correlating the real-time data monitoring with physical location. This provides a method for the program 110 creating a three dimensional (3D) map which plots an agents concentration and distribution over time. In addition to providing continuous updates and analysis of exposure specific to the individual end-user, this methodology also allows the program 110 to provide continuous monitoring and analysis data specific to the agent and location in space.

Continuous data monitoring can also be performed using stationary measuring devices which are physically positioned in predefined locations, in order to cover a large geographic area, for the purpose of environmental data recording and analysis extrinsic to individual end-users. A relevant example of how this would be employed is in household detection of radon, which is a common (and under-detected) source of everyday radiation exposure. Radon sensors could be distributed throughout the household in a fashion similar to carbon monoxide or heat sensors in order to continuously monitor radon levels in the local environment, in order to provide real-time measurements over time to the program 110, which data can also be used to predict future exposure levels. This would be especially important in the event that young children (who are particularly susceptible to radiation injury) are in physical proximity. If for example, a baby was recently born, the data could be used for the program 110 to analyze same, and to notify and educate the parents of measured radon levels, to educate them as to the associated risks (specific to both the newborn and other family members), and provide them with educational information regarding strategies to reduce radon levels and associated risk. In this application, the present invention serves as an important educational and interventional tool.

In the event of a terrorist attack or natural disaster, the continuous monitoring by the program 110 of data being recorded by multiple end-users (i.e., mobile sensors 23) and geographically distributed (i.e., fixed) sensors 23, could effectively create a distribution and concentration map of the agent (e.g., radiation, carcinogen) relating to physical location and time. For airborne or waterborne agents which actively travel over time, this would serve as an effective and relevant example to illustrate how this might be applied is the recent disaster at the Fukushima Daiichi nuclear power plant in Japan. Radioactive spillage from this disaster created a health risk for local inhabitants based upon airborne radiation, which could be tracked by the program 110 using mathematical modeling in accordance with the magnitude of the radiation released and wind patterns over time. This data could in turn be correlated by the program 110 with the predictable half-life of the radiation in order to predict future exposure based upon decay.

At the same time however, radiation leaked into local water supplies to produce radioactive groundwater, which could spread into adjoining water supplies, thereby creating widening environmental damage and risk in an alternative method of radiation contamination. The combination of fixed and mobile data would effectively produce a real-time map of exposure, which when correlated by the program 110 with air and water flow data, can provide local authorities with a method for continuously updating and predicting future exposure levels. This could in turn lead to data-driven interventional strategies for reducing health risks.

The predictive modeling capabilities of the program 110 of the present invention can also play an important role in analyzing contagions (e.g., virus or bacterial agents), which can actively spread throughout a populace to produce widespread dissemination and illness. The ability of the program 110 to simultaneously track and analyze the concentration and distribution of the agent in question and local populations serve as a valuable tool for both predicting illness and spread. When this data is in turn correlated by the program 110 with healthcare data from local healthcare facilities (e.g., emergency rooms, outpatient centers), the combined analyses can be used by the program 110 to predict transmission rates, pathogenicity, and assist in devising interventional strategies for containment and treatment.

In addition to solitary analysis of a local pathogen, the program 110 can use this same modeling for multi-location tracking. As an example, in the event of an endemic pathogen like influenza, the agent in question is rapidly spreading throughout multiple geographic locations simultaneously. Having the ability of the program 110 to actively track and monitor data through a centralized database 113, 114 (e.g., by the Centers of Disease Control) creates a mechanism to predict spread over a large geographic region and populace, determine pathogenicity, predict origination, and identify at-risk populations.

This ability to provide risk analysis is especially important in high risk individuals (e.g., young, elderly, physically compromised individuals). The real-time exposure data being recorded by the program 110 in the database 113, 114, along with projections based upon magnitude, location, and directionality can be customized in accordance with individuals' profiles to provide up-to-minute risk analyses. Categorized risk assessments can be created by the program 110 with the ability to provide automated alerts and prompts to healthcare providers (both at individual and institutional levels), law enforcement agencies, and public safety providers to proactively assist with disaster prevention, intervention, and recovery efforts.

In addition to targeted alerts to providers and safety officials, individuals can also be provided by the program 110 with customized alerts based upon their individual profiles and risk assessment, specific to the agent being monitored. In addition to public alerts, recommendations, and treatment plans being offered, these customized analytics output by the program 110 can also be accompanied by targeted educational information, which is also guided by the individual end-user profile (which contains data related to education/training, compliance, socioeconomics, prior history, preferred methods of communication, and computer proclivity).

The integrated GPS functionality of the present invention can also be used for intervention and guidance, for the purposes of expediting and promoting ongoing safety efforts. As an example, in the event of a large-scale radiation or biologic agent disaster, the real-time data analyses run by the program 110 will identify the specific agent of concern, determine quantitative levels of this agent, create a vector analysis of migration, perform customizable context and user-specific risk analyses (based upon individual profiles), and identify nearby “safe areas” (i.e., specific geographic areas and physical locations in close proximity with lower exposure levels. Using GPS and the specific location of the individual in question, the program 110 can be used to provide guidance to the individual in reaching these safe areas. This active guidance by the program 110 can take a number of forms including (but not limited to) providing directions to nearby safe areas, color coded feedback tracking ongoing measurements as the individual travels, and heat maps demonstrating differential levels and associated risk over a local geographic region. The delivery, content, and display methods of this user-specific guidance can be customized to the specific needs, preferences, and technologies used by an individual. One end user may prefer voice guidance through headphones, another color coded route navigation through a cell phone, and another text based instructions and updates through e-mail or text alerts.

Both the GPS and sensor technologies can be contained within a number of portable devices including (but not limited to) jewelry, watches, smart phones, and RFID bracelets. These provide two-way functionality for both receiving and transmitting data, with the ability to continuously communicate with databases (which contain the individual person's profile), updating and extracting pertinent data and analytics in real-time.

Another application for the external monitoring and measurement of environmental radiation (or other agents posing healthcare risk) is that of the ability to rapidly mobilize and relocate external sensors 23 at the point of concern, in the event of a man-made or natural disaster. In the event that an unusually high level of an agent is detected by the program 110 and verified in a specific location, mobile sensors 23 can be automatically dispatched by the program 110 to the geographic area of concern using GPS technology embedded in the sensors 23. Examples of when these would become applicable may include deployment of a dirty bomb, localized outbreak of a biologic pathogen, or contamination of a water supply. The ability of the program 110 to rapidly mobilize mobile sensors 23 plays a critical role in being able to continuously monitor environmental exposures without employing unusually large numbers of fixed sensors 23 throughout large geographic regions. A number of methods can be used to transport these point-of-concern mobile sensors 23 including (but not limited to) self-propelled motorized devices (which can travel over land, air, or water), drones, tandem devices (which can be attached to guidance devices and deposited at the geographic location of interest), and projectile or propulsion devices (which can be transported as a projectile and linked to a guidance system for accurate localization).

The derived analytics can be performed in both manual and automated fashions. The automated analytics performed by the program 110 are predefined in accordance with protocols defined by the individual end-user and their peers (i.e., other users with similar profile characteristics), as well as analytics defined by designated healthcare providers (e.g., primary care physician, consulting radiologist). Manual analytics are those performed by the program 110 in response to a specific inquiry (e.g., comparative assessment of differing radiation dose estimates for different CT technologies); which can be generated by the individual patient or healthcare provider.

These analytics by the program 110 can be copied and/or forwarded to an individual's designated community of providers and partners. The access of this data is automatically recorded by the program 110 in the appropriate databases 113, 114, once an end-user has been authenticated and verified using biometrics by the program 110. This provides a tool for documenting receipt of data, derived analytics, warnings, and recommended interventions.

All communications between these multiple parties are simultaneously recorded by the program 110 in the database 113, 114, along with links to the corresponding data. These communications can take a number of different forms including (but not limited to) electronic text messages, e-mail, telephone conversations (i.e., voice files), or video. These communications can be hierarchically ranked (e.g., color coding) by the program 110 in accordance with priority and time urgency, with separate requirements for receipt confirmation. In the event that a critical communication is not acknowledged and/or acted upon by the program 110 in the designated time frame, an automated escalation pathway can be activated by the program 110, which automatically transfers communication responsibilities to a third party (e.g., family member, consulting physician) to ensure timely action and follow through.

This continuous data measurement and analysis correlated with GPS location tracking by the program 110, can be simultaneously recorded by the program 110 into a series of databases 113, 114, which provide local, regional, and national analytics. This effectively provides researchers, healthcare providers, and public safety officials with trending analysis on multiple levels which can assist in early diagnosis and intervention efforts. If for example, a series of water supplies over a diverse geographic range are contaminated with a biologic agent, the program 110 would be able to identify similarities in data and trends, which might otherwise go undetected, and in turn take proactive steps to safeguard other potential high-risk targets.

In addition to customized measurement, recording and analysis of single agents, the program 110 of the present invention can also support parametric data analysis, in which multiple agents are simultaneously analyzed. This is particularly important when individual agents interact with one another in a way that affects clinical outcome and risk. As an example, research may demonstrate that airborne exposure to silicates has a negative synergistic relationship with airborne exposure to allergens (e.g., pollen) to produce an increased risk of developing pulmonary infections and/or neoplasms. While the overall risk could be extrapolated to a large population based upon large sample size statistics, the individual (i.e., customized) risk would be determined by the program 110 in accordance with analysis of an individual's profile and corresponding risk factors (e.g., genetics, medical problem list, pharmaceuticals, pulmonary and immune statuses, etc.). This represents an important and unique attribute of the present invention in that those exposure measurements analytics can be performed by the program 110 on individual or groups of agents.

While not customarily thought of as an “exposure agent”, another class of agents which can be included in the profile and database is that of pharmaceuticals. These agents are particularly important since they not only produce therapeutic responses to medical conditions, but also have the potential to cause or exacerbate other medical problems. It is well established that all pharmaceuticals have associated side effects (i.e., their own clinical profile), which may be transient or cumulative in nature, and varies in accordance with the individual patient's profile. If, for example, a patient is being treated with a medication that has well documented toxicity (e.g., nephrotoxicity) proportionate to cumulative dose, it is important that the program 110 record, monitor, and analyze both individual and cumulative doses of that pharmaceutical, while correlating that data with the individual patient profile to determine toxicity risk. The analysis of this longitudinal data by the program 110 in combination with the individual profile analytics can be used to guide medical treatment planning (i.e., decision support), which could include modifying the dose regimen, changing pharmaceutical agents, or performing clinical tests (e.g., renal function tests like GFR) for identifying early warning signs of clinical disease. If this data is subsequently combined by the program 110 with data of other agents associated with potential nephrotoxicity (e.g., radiation), the combined data could have the program 110 produce a “comprehensive organ system risk analysis”, which would take into account the individual risk factors associated with each individual agent's exposure along with the additional risk produced by synergistic interaction between multiple agents.

The ability of the program 110 to perform large sample size statistical analysis using standardized data, while also accounting for individual variation (based upon profile characteristics) creates the ability to objectively and dynamically quantify risk of individual and combined agents, based upon empirical and clinical outcome data analysis. The dynamic and ever changing data measurements (and derived analytics) in association within an individual profile allows the program 110 to create an up-to-the-minute tool for guiding clinical intervention, prevention, surveillance, and interventional strategies. These can be referred to as “continuous cumulative risk scores”, which can be classified by the program 110 in accordance with an individual agent (e.g., toxin), organ system (e.g., pulmonary), disease process (e.g., malignancy), or geographic location (e.g., city).

To illustrate the practicality of these customizable risk scores, an example of a commonly experienced environmental agent such as airborne pollutants, is considered. In conventional practice, healthcare entities will often issue pollution warnings when a certain pollutant reaches a critical threshold, which is determined to incur increased risk for respiratory disease and/or impairment. The problem with this current practice is that it is often nonspecific in geographic location and individual patient risk, merely serving as a warning to the general population over a large geographic region.

However, using the program 110 of the present invention, a specific agent (or groupings of multiple agents) deemed to be detrimental to respiratory health, can be measured specific to each individual person (e.g., using wearable or embedded sensors 23), and specific to an individual geographic location (e.g., using permanently stationed sensors 23 affixed to physical structures). As individuals travel over a given geographic region, the combined data measurements attributed to their own embedded sensors 23, data recorded by other persons traveling within a geographic proximity, and data recorded by fixed sensors 23 can be used collectively by the program 110 to produce a real-time vector analysis of individual agents, which when combined with external weather conditions (e.g., heat, wind direction), can produce dynamic actual and predictive exposure measurements. When these data are correlated by the program 110 with the changing position of the individual person and their profile analytics, a customizable continuous cumulative risk score can be derived and delivered to the individual in accordance with their predetermined communication and education preferences. In this example, a person who is at increased risk for pulmonary compromise (e.g., patient with emphysema, longstanding smoker, recently treated lung infection) would be alerted by the program 110 via electronic means (i.e., cell phone, text etc.) to the individual risk, along with recommendations for intervention (e.g., change in activity, directional change in travel, wearing of mask, prophylactic use of inhaler).

In addition to customizable (user-specific) alerts, the derived analytics by the program 110 can also be used for generalizable alerts. Using the prior example of pollutant measurement and analysis in an urban area, the analysis by the program 110 may determine that a threshold has been achieved which places certain profiles at high risk. In addition to automated alerts (i.e., cell phone, text, fax, etc.) by the program 110 to individuals which subscribe to the option, an alternative strategy would be to provide generalized alerts to the larger population, which can take a number of different forms. One option would be to utilize public communication methods in or in close proximity to the geographic region of concern (e.g., electronic billboards, text), while an alternative strategy would be to send out electronic warnings to non-subscribers who are travelling in the area and/or direction of concern. These warnings can be integrated into wireless technologies (e.g., smart phones, laptops, MP-3 device), which are synchronized with GPS to identify individuals within or travelling into the geographic region of risk. Along with the generalized information warning, the message sent out by the program 110 can communicate specific profile groups determined to be “at risk” (e.g., color coding in accordance with different risk levels). As an example, a person driving in their car may pass by a series of billboards (or other visible modes of communication) which alerts them to the exposure warning, agent/s of concern, geographic distribution, and profile groups at increased risk. In addition, the message output by the program 110 may also contain an educational link (e.g., URL) in which interested parties can activate and synchronize their personal profile database 113, 114 in order to received customized analytics. Other common examples of everyday encountered environmental agents may include (but not limited to) allergens, pollutants, electromagnetic radiation, and heat index.

Along with the ability of the program 110 to automatically send customized alerts to high risk individuals (in accordance with profile analyses), these automated alerts can be simultaneously transmitted to designated caretakers (e.g., guardian, primary care physician, surgeon, in order to facilitate and coordinate improved healthcare delivery and preventative measures. As an example, if a critical exposure threshold is achieved for a specific patient in the care of a primary care physician (or physician specialist), an automated notification pathway can be triggered by the program 110 based upon a pre-defined schema. The automated alert can contain a wide array of data including (but not limited to) the identification of the patient, their individual profile information, the specific agent/s of interest, the recorded measurements of these agents (which can take into account fixed measurements recorded by the patient, geographic measurements, and mobile measurements recorded by other persons in the immediate geographic area and direction of patient travel), patient-specific analytics related to current, historic, and future exposure predictions, and continuous cumulative risk scores. Using these data and integrated decision support tools, the physician could in turn communicate directly with the patient (e.g., telephone, e-mail, video) to discuss medical implications, options, and interventional strategies. Both the communications and data used in these communications can be recorded by the program 110 into the patient, physician, and centralized profile databases 113, 114 for future review and analysis. The goal is to create a method of supporting best practice guidelines, education/training, and accountability.

In the event that a wide-scale healthcare risk has been identified by the program 110 based upon real-time fixed and mobile exposure measurements (e.g., dirty bomb, radiation/gas leak, water supply contamination, infectious agent dissemination); the derived data can be used by the program 110 to propagate risk alerts (which can be general and/or specific to individuals), recommendations, and educational information. At the same time, both actively measured data and derived analytics produced by the program 110 can be used by healthcare, security, and first responder professionals to identify the agent source, method of propagation, directionality of spread, population risks, and containment/treatment strategies. In the case of infectious agents, proactive strategies for quarantining, triage, and treatment can be facilitated by the program 110 using these data, while also utilizing the individual profile database analytics to create personalized risk scores in order to prioritize these interventional strategies. One could envision the scenario where a terrorist could effectively be tracked by the program 110 using real-time data measurements recorded by fixed geographic measuring devices, along with mobile measuring devices attached to passersby. The real-time redundant data from these multiple sources could effectively be used by the program 110 to create an intensity and directionality map of a mobile agent, which also serves to predict “at risk” geographic locations, potential targets, and individuals over time. The ability of the program 110 to simultaneously comingle data from multiple end users provides an additional resource for multi-source data collection in real time. In this scenario the individual end users in transit effectively become mobile sensors, each of which provides complementary data to that of nearby end users, thereby expanding the accuracy and quantity of collected data.

In addition to recording quantitative data specific to an exposure agent, the program 110 of the present invention could also be used to qualitatively analyze the agent in question. As an example, if the agent of interest is electromagnetic radiation, the sensor technology could provide the program 110 with information which can be used to simultaneously characterize the amplitude, frequency, and wavelength of the radiation, which provides important information to characterize the specific type of electromagnetic radiation. This ability to sub-classify radiation adds depth to the program 110 and specificity in risk calculations.

In a similar fashion, the measuring technologies used to record agent exposure for the program 110 could also capture samples of the offending agents over geographic distributions and time. This provides a program 110 tool for characterizing the number and types of exposure sources, as well as genetic modifications or mutations. In the examples of two different infectious agents, a naturally occurring virus and a man-made biologic agent (e.g., anthrax), the sampling of these agents by the program 110 could be used for genetic characterization. In the example of a biologic terrorist act, multiple synchronous or asynchronous exposures could take place over a wide geographic area. The ability of the program 110 to sample and characterize the agents allows for scientists, healthcare, and law enforcement officials to determine the number and locations of outbreaks, biologic risk, and potential sources of the act. In the example of a naturally occurring exposure (e.g., influenza), the collection and analysis of sources by the program 110 over different geographic regions and time periods allows for scientific classification of the agent, mutational changes, biologic risk, and treatment planning. Once again, the derived data could be cross-referenced by the program 110 with centralized and local profile databases 113, 114 to identify individuals at high risk and used for notification and preventative action.

One of the additional features of the present invention is the incorporation of a quality assurance (QA)/quality control (QC) program 110, which ensures the equipment used and measurements obtained are accurate, reproducible, and secure. An internal QA/QC program 110 can be developed to routinely test, calibrate, and monitor data being recorded with fixed measurement devices (e.g., sensors 23), which can be intrinsic to individual persons (i.e., as either wearable, embedded, or portable sensors 23) or structures 23 in the local environs.

An external QA/QC program 110 would include a more detailed analysis, which can be performed by a skilled technician using phantoms or standardized samples of the agents of interest, which test the device's quantitative and qualitative accuracy.

A third form of QA/QC can be performed by the program 110 correlating data from physically located devices 23 in close proximity, to ensure that the measurements recorded are consistent with one another over time. This third from of QA/QC utilizes program 110 comparative data mining, while the former two techniques utilize physical measurements and equipment calibration. In the event that a specific device is found to have faulty or suspect data by equipment check or data analysis, the measured data from that device 23 (as well as derived analytics by the program 110) would be temporarily be discarded until data verification and equipment testing can be completed. Triggers for such QA/QC testing can also be automatically mandated by program 110 rules when aberrant data is recorded by the program 110. The threshold for these automated QA/QC triggers can take a number of forms (based on desired sensitivity/specificity levels), specific to the individual agent and risk being evaluated. As an example, if a device 23 was to record a measurement which is greater than 2 standard deviations beyond recent measurements (in time or space), as analyzed by the program 110, then an automated alert would be sent by the program 110 to analyze the database 113, 114 and institute QA/QC testing procedures for the data outlier, and institute a requirement for additional testing and data verification.

Since one of the applications of the present invention is individual, local, regional, and national detection of a number of different harmful agents, it is important that the integrity of the entire data collection and monitoring system 100 be ensured. This becomes a practical issue in the event that either a third party attempts to deliberately sabotage the system 100, or the system 100 becomes impaired by a large-scale natural disaster. In either scenario, it is critical that safeguards be implemented to ensure that data collection and gathering, transmission, and storage are maintained in a secure fashion. Strategies including (but not limited to) data redundancy, alternative power supplies, data collection backup, data re-routing, and encryption can all be incorporated into the program 110 and the system 100 in an attempt to safeguard against operational and security failure. Simple security measures such as implementation of biometrics (for end-user verification and validation) and dual user authorization requirements can be incorporated into system 100 procedures for all administrative personnel, to facilitate accurate tracking of data access, retrieval, modification, and delivery. In the event that a data breach or failure occurred at any point(s) in the system 100 network, an automated alert would be sent by the program 110 to administrative personnel notifying them of the issue, location, date/time, and causative factors. At the same time, simultaneous notifications would be transmitted by the program 110 to other nodes within the system 100 network for the purposes of notification, increased alert status, and implementation of corrective actions.

Simulation modeling can be performed by the program 110 using the profile data and derived analytics in an attempt to predict future patterns and actions, in accordance with dynamic data measurements and trending analyses. As an example, if a large-scale disaster was to take place (e.g., nuclear reactor meltdown), placing a large geographic region and population to dangerous radiation exposure, the combined data obtained by the program 110 from local monitoring devices 23, profile database 113, 114, and weather patterns (via monitoring devices 23), could be combined using artificial intelligence techniques run by the program 110, to create program-derived models for predicting future radiation dose levels, geographic distribution of radiation, and morbidity/mortality in accordance with local population radiation profiles. At the same time, this predictive modeling can be used by the program 110 to test different strategies for containment, intervention, and medical treatment, with the goal of optimizing disaster recovery efforts.

A complementary component of the present invention and to the inventor's Radiation Scorecard of U.S. patent application Ser. No. 11/976,518, as noted above, is the creation of a Radiation Checklist (which can also be created for the various other exposure agents described). This checklist serves as an easily accessible list of customizable “to do” items (in accordance with the end-users' Radiation Profile), which serves as a guide to facilitate improved compliance with guidelines and standards, while also promoting customized educational and decision support tools. The Radiation Checklist can be manually accessed at the end-user's request or automatically presented by the program 110 when a specific task is performed or when inadequate/insufficient data is recorded by the program 110 in the Radiation database 113, 114. An example of an automated prompt would be when a physician is ordering a medical imaging examination (with ionizing radiation) and does not access the patient's Radiation Profile during the order entry process. In this situation, the program 110 would note the discrepancy and issue an automated prompt to notify the ordering physician of the oversight and request that he/she acknowledge receipt of the alert, review the profile data, and consider decision support recommendations provided to improve radiation safety specific to that patient's Radiation Profile.

The Radiation Checklists of the present invention are designed to improve data access, decision making, and compliance with “best practice” standards. As a result, different checklists are created by the program 110 for different user groups including (but not limited to) patients and family members, healthcare providers, radiation consultants (e.g., medical physicists), technology producers, and insurers. The checklists provide a cumulative snapshot as to how supporting technology is being used (or not used), compliance with standards and best practice guidelines, and utilization of education and decision support tools. Examples of metrics contained within these checklists include: compliance with guidelines and recommendations, education and decision support resources, communication and follow-up, and technology utilization, and vary in accordance with these different user groups. Note that customized and adaptive checklists are created by the program 110 in accordance with individual users' Radiation Profiles and include different user groups including (but not limited to) patients, family members, primary healthcare providers, physician and nurse specialists, consultants, payers, and technology providers.

In addition to the ability for customization, the present checklists can be adaptive by the program 110 to the needs and usage patterns of individual users. As an example, if an individual end-user is repeatedly forgetting or intentionally failing to follow certain checklist items, the program 110 can adaptively create automated alerts and reminders, in an attempt to increase compliance and overall performance (with respect to established guidelines and recommendations). In addition to these adaptive alerts, other features can be implemented by the program 110 such as reprioritization of specific checklist items, modifications in the way these are presented for review (e.g., auditory cues), or incorporation of mandatory inputs which prevent closure of the application until data input has been completed. This adaptive functionality can also be applied by the program 110 to the technologies in use (e.g., wearable radiation sensors 23, fixed household radon sensors 23). In the event that data is not being actively recorded by the program 110 from these devices 23, automated alerts will be sent by the program 110 to both the individual end-user and the corresponding databases 113, 114, in order to record insufficient data and attempt to rectify the problem. This same scenario can also be used to identify faulty or non-functioning technology.

Rewards and incentives can be integrated by the program 110 into checklist usage in an attempt to encourage improved checklist compliance and overall performance. As an example, an insurer may provide economic incentives to healthcare providers (e.g., increased reimbursements) and patients (e.g., decreased insurance premiums) when users' are consistently adhering to checklist recommendations and guidelines, while providing complete data for longitudinal analysis. At the same time, technology performance data can be made accessible to the public with the goal of incentivizing technology producers to improve performance and reliability of the technology in use.

The combined data and analysis of the Radiation Profile and Radiation Checklist provides important insight as to overall radiation risk, specific risk factors of concern, degree of end-user involvement and compliance with standards and guidelines, and relative success of treatment and interventional strategies specific to different end-user groups. In order to support and maximize positive clinical outcomes, this data can in turn be used by the program 110 to promote radiation consultations, which are performed by specialized providers from a variety of different educational and training backgrounds, each with their own style and expertise designed to enhance education, compliance, decision support, prevention, and treatment of radiation safety efforts. The consultants can work in collaborative teams or in isolation to one another and can be selected based upon the specific profile and needs of the individual end-user. The types of expert consultants would include (but not limited to) medical physicists, nutritionists, lifestyle coaches, nurse educators, radiologists [both therapeutic and diagnostic], technologists, device manufacturers and application specialists, primary care physicians, radiation safety officers, and specialty physician consultants.

Another important analytic outcome of the present invention and profile database 113, 114 is the creation of quantitative accountability, relating to exposure-related adverse outcomes. Relevant examples include (but are not limited to) asbestos related lung malignancies (i.e., lung cancer and mesothelioma), radiation-induced burns, drug-induced pulmonary fibrosis, and coal workers' pneumoconiosis (i.e., black lung). In all of these examples, an occupational, environmental, or medicinal related exposure led to an otherwise preventable disease (i.e., morbidity) and potential death (i.e., mortality). Many lawsuits are filed annually related to such events, with the hypothesis that improper exposures (which could be the result of excessive, preventable, and/or unmonitored exposures) led to preventable disease. One of the principle challenges in these cases is demonstrating a causative relationship between exposure and disease, in the absence of reproducible and objective data relating to the source of the agent in question, timing and quantity of exposure, technology in use, and role of individual parties. For the example of a radiation-induce burn during the performance of a medical procedure, a number questions (not limited to the following) may be presented by the program 110 in order to accurately determine causation:

a. What was the exact date and time of the presumed causative event?

b. What was the specific quantity and timing of radiation administered (i.e., radiation dose), and to what anatomic regions were affected (i.e., critical organs)?

c. What specific technologies played a role in radiation delivery (e.g., CT scanner) during this event and was that technology correctly being monitored and scrutinized for safety and clinical efficacy (i.e., CT quality control)?

d. What role did human error play in the administration of ‘excessive” radiation? Who were the parties involved (e.g., technologist performing the exam, radiologist supervising the exam, and clinician ordering the exam) and were their actions consistent or inconsistent with the standard of care?

e. Were there additional mitigating factors that may have contributed to the adverse outcome (e.g., pharmaceuticals or topical agents increasing radiation susceptibility)?

f. Did the patient play any contributing role in the adverse outcome (e.g., noncompliance with recommended therapy, uncooperative during exam performance)?

g. What role could other radiation sources have played in causing or contributing to the adverse outcome? These could include synchronous and asynchronous radiation exposures related to occupational, recreational, medical, and/or environmental radiation sources.

Without this data, it is difficult to accurately determine accountability and causation, since human, technology, and procedural issues are potentially play a role. The ability of the program 110 to create and analyze radiation profile databases 113, 114 (for the patient, healthcare providers, and technologies in use), create an objective method of determining the individual and collective roles these factors play in clinical outcomes. The knowledge derived from these analyses also provides a valuable tool for education/training, creation of best practice standards and guidelines, and decision support tools.

A number of medical decision support applications can be derived by the program 110 from the database 113, 114 and analytics, specific to the Radiation Profile invention, which can be expanded to include not only individual patients but also individual and institutional providers. An example of a patient-specific decision support application would be that of a tool which allows for patients to input into the database 113, 114 a medical procedure associated with ionizing radiation (e.g., chest CT) along with corresponding ordering clinical information. This could most easily be performed by inserting into the database 113, 114, the ordering information filled out by the ordering clinician (which could automatically be performed by the program 110 integrating the patient Radiation Profile with the ordering technology (e.g., radiology information system (RIS), computerized physician order entry system (CPOE), or electronic medical record (EMR)). The Radiation Profile program 110 (along with the program 110 of the Radiation Scorecard) would in turn automatically generate radiation dose estimates for the exam ordered (which takes into account the exam type, anatomic region, clinical data, and patient-specific attributes). These exam and patient-specific radiation dose estimates would then be presented by the program 110 to the patient in a number of different manners, which include (but are not limited to) the following:

a. Estimated whole body radiation dose estimate (mean)

b. Organ specific radiation dose estimates (mean)

c. Estimated radiation dose estimate ranges using different protocol options

d. Estimated radiation dose estimate ranges using different technology options

e. Estimated radiation dose estimate ranges using different institutional providers

f. Alternative exam/procedural options based upon clinical order and organ system of interest

g. Associated radiation dose estimates of alternative exam options

The patient (or designated caretaker/advisor) could then have the program 110 generate a more targeted query, specific to their individual needs and preferences. As an example, if a patient is particularly concerned about maximizing radiation dose reduction for the exam being requested, they could request the lowest radiation dose estimate from the program 110 through protocol optimization. The Radiation Profile program 110 would then provide the patient with the lowest estimated radiation dose in keeping with the patient-specific profile, exam type, and revised protocol. If the patient wanted to further inquiry as to whether technology or institutional provider selection could play a further role in estimated radiation dose reduction, he/she could add these variables to the program 110 search analytics to arrive at a “lowest radiation dose estimate” taking into account all three search variables (i.e., protocol, technology, and provider). The decision support application of the program 110 could even go one step further (when integrated with the Radiation and Quality Scorecard databases 113, 114) to identify providers in a defined geographic area which fulfill the search criteria. (Note that one could even add the variable of quality ratings to the program 110 search to provide a combined analysis of radiation dose and quality performance).

Once the patient (or their designate) has completed their radiation dose data search, they can instruct the program 110 to incorporate this data (which is estimated, since it has not been finalized) into their personal profile, with revised radiation risk analyses. This provides the patient with an ability to perform a radiation risk analysis prior to the performance of a specific medical procedure or exam and make informed decisions in keeping with their own healthcare concerns, preferences, and priorities.

An example of a non-radiologic diagnostic medical procedure which is relevant would be that of a cardiac catheterization, which is commonly performed in the evaluation of coronary artery disease, and can in turn lead to therapeutic coronary artery angioplasty. A large number of operator, technology, clinical, and patient-specific variables ultimately play a major role in determining the radiation dose associated with these procedures. By the program 110 taking into account the unique attributes of the patient (e.g., body habitus, compliance) and their medical history (e.g., pre-existing cardiac disease, prior coronary artery procedures/surgeries), the program 110 can more accurately predict radiation dose estimates. At the same time, since some operators (i.e., interventional cardiologists) are more technically skilled than others, operator-specific historical radiation dose and clinical outcome measurements become important differentiators in the program 110 optimizing calculations of radiation dose estimates, as well as provider selection. These calculations and selection options may become even more granular when the program 110 uses patient-specific profile characteristics in the analysis.

As an example, a patient who is morbidly obese, extremely anxious, and has a prior history of coronary artery bypass would be a far more technically challenging than the vast majority of patients undergoing this planned procedure. Rather than searching different operator radiation dose estimates for “all patients”, the person performing the search of the databases 113, 114 may prefer to limit the search for “patients with similar profiles”. The program 110 generated analysis could in turn identify key features within the specific patient profile to narrow the search parameters and in turn generate patient-specific operator radiation dose estimates. (In addition to allowing the program 110 to identify the key search features, an end user can also perform a manual search where they input the search features of interest.)

In addition to diagnostic medical procedures, the same type of patient-directed decision support can be performed by the program 110 for therapeutic procedures associated with ionizing radiation, including radiation therapy (both brachytherapy and external beam radiation therapy) used for treatment of malignancy. Since the range of radiation dose estimates for cancer treatment can be extremely large, depending upon the operator, protocol, technology used, and institution, it is important that the program 110 and derived analytics support the ability to define search criteria in accordance with the specific needs and preferences of the individual. This is of particular importance when a patient is presented with different medical opinions (or options) regarding recommended cancer therapy. The patient could input the different options into the program 110 and review the resulting radiation dose ramifications associated with these options, along with the risk of radiation-induced complications and disease.

In the same manner, these described decision support applications can also be used by healthcare providers (and payers) in estimating radiation dose associated with a procedure or exam, assisting in exam and protocol optimization, and providing data-driven support for provider and technology selection. In all applications, the key feature is that the analyses are performed by the program 110 in keeping with patient specific analysis of the Radiation Profiles. This underscores the important concept that “best practice” often changes in keeping with unique attributes of the individual patient, which includes (but are not limited to) cumulative radiation history, genetics, personal biases and prejudices, body habitus, health awareness, underlying medical history, social history, and age.

Another application of the present invention and the derived data analyses of the program 110, is education, which can be customized and adapted by the program 110 to the individual needs of patients, healthcare providers, consultants, administrators, and payers. Since most patients (and a great deal of healthcare professionals) do not fully understand radiation dose calculations, medical risks and complications, and alternative diagnostic and treatment options, the educational options derived from the Radiation Profile program 110 is unique and informative. A physician ordering a diagnostic medical imaging exam may not be aware of the associated radiation dose, alternative imaging options, or long term risk to the patient. By the program 110 directly providing the option for this analysis at the time of order entry, the physician can be better educated and in theory, improve patient-specific healthcare outcomes proactively. In addition, in the event that a radiation safety outlier is identified upon longitudinal analysis by the program 110 of the Radiation Profile and Radiation Scorecard databases (e.g., physician excessively ordering diagnostic imaging exams with radiation, a specific technology (e.g., CT scanner) or operator (e.g., technologist) with higher levels of radiation dose than its peers, or an administrator with insufficient radiation safety related to pregnancy), the program 110 can be adjusted to alert the radiation safety and/or compliance officers and providing automated decision support for intervention.

Derived analytics of the Radiation Profile program 110 can also be used to facilitate improved healthcare economics. Payers could tie a certain portion of technical and professional reimbursements to radiation safety measures and compliance with “best practice” guidelines. At the same time, patient insurance premiums can in part be tied to patients' participation in radiation safety, education, and interventional efforts. As an example, a patient who has a consistently high compliance rate related to continuous radiation dose monitoring (e.g., through the use of a wearable radiation sensor 23 technology), may be rewarded by having a reduction in their annual medical insurance premiums. Alternatively, a physician provider who recognized that a specific patient has crossed over from a “low risk” to “intermediate risk” category of radiation risk and subsequently utilized to a higher degree the decision support applications of the Radiation Profile program 110 to reduce patient radiation in lung cancer surveillance, may be rewarded through a radiation safety financial bonus. Even technology producers may be financially incentivized through the creation of federal grants or tax incentives to invest in R & D efforts aimed at radiation dose reduction and safety through new and improved technology development.

In order to illustrate the methods of the present invention, a few relevant examples will be provided which demonstrate the functionality, analytics, and decision support/educational programs intrinsic to the present invention and its program 110 and derived databases 113, 114.

Radiation Routine Medical Evaluation

In this example, a recently relocated patient presents for a first time visit to a primary care physician for worsening cough. The use of the Radiation Profile program 110 and database 113, 114 provides an objective and data-driven method for improved medical diagnosis, radiation safety, and clinical outcomes.

1. Patient makes appointment with a new doctor for a chronic cough.

2. When taking history, PCP realizes that patient is a poor historian resulting in limited and incomplete medical history.

3. PCP elects to order a chest CT to evaluate chronic cough.

4. When order placed, the patient medical databases 113, 114 are queried, including Radiation Profile database 113, 114, which is automatically activated and analyzed by the program 110 relative to the new chest CT order.

5. Computerized analysis of the patient's Radiation Profile by the program 110 provides the PCP with a number of patient-specific analytics including (but not limited to) cumulative medical radiation exposure, radiation risk, confounding variables (affecting radiation risk), dose estimates associated with the study being ordered, and alternative strategies for dose reduction.

6. In the comprehensive analysis of radiation risk and confounding variables by the program 110, a number of patient-specific data elements are identified by the program 110 which are associated with increased radiation risk (i.e., radiation risk accelerants) specific to the chest CT order placed which include chronic interstitial lung disease, medication (i.e., amiodarone for cardiac arrhythmia), and multiple prior chest imaging exams with ionizing radiation.

7. The computerized decision support application of the program 110 provides the PCP with a number of recommendations for radiation dose reduction and decreased radiation-induced complications. These include adjustment of medication (i.e., discontinuation of amiodarone) and performance of requested chest CT using a ultra-low dose protocol with specialized image processing and noise reduction filters.

8. The PCP accepts the program 110 recommendation for CT protocol optimization and requests a cardiology consultation to evaluate alternative medications for treatment of the cardiac arrhythmia.

9. Before the chest CT order is executed, the PCP is given the option, by the program 110, of reviewing Radiation Profiles of CT imaging providers in the local geographic area, with the goal of optimizing radiation safety and image quality.

10. The data-derived analysis by the program 110, provides the PCP with departmental performance data of local imaging providers, which can be further analyzed on a more granular level to evaluate CT technology in use and individual technologist/radiologist performances. (A portion of this data is directly derived from the Radiation Scorecard invention).

11. When the PCP reviews this data, he changes the order request to coincide with the specific recommendations of the Radiation Profile decision support application of the program 110, and requests that the order be placed at the highest ranking CT provider site within 15 miles.

12. The Radiation Profile program 110 complies with this request and places the order with specific protocol instructions at the highest ranking site which fulfills the requested ordering criteria.

13. In addition, the Radiation Profile program 110 provides the PCP with performance data of local cardiologists for guidance in consultant selection specific to the clinical context.

14. The Radiation Profile program 110 also alerts the PCP to the fact that data within the patient-specific Radiation Profile database has been incomplete for the past 6 months, which may limit the accuracy of the derived analytics.

15. The Radiation Profile program 110 provides the PCP with a patient-specific Radiation Checklist to assist in patient education, continuous data collection, and interventional strategies for enhanced radiation safety.

16. The PCP reviews the Radiation Checklist with the patient and learns that many of the requisite data, supporting technologies, and educational resources are not in current use by the patient. He in turn counsels the patient as to the need for compliance and requests a Radiation Safety and Education consultation.

17. This radiation consultation order is reviewed by the Radiation Profile program 110 to identify credentialed professionals in the local area, their overall performance data, cost (including insurance options), and education and skill sets specific to the patient's Radiation Profile.

18. A number of items in the patient's Radiation Profile were used by the program 110 to identify the ideal match for the consultant including the longstanding patient history of noncompliance, limited education, complicated medical history, longstanding smoking and alcohol consumption, and mildly compromised immune status. The resulting consultation recommendation by the program 110 focused on someone with a formal medical knowledge, experience with patient education, and good motivational skills. In this instance, the optimal match was that of a nurse educator with specialized training in radiation safety.

19. Upon completion of the consultation, a number of important facts related to the Radiation Checklist and Profile were elicited. Foremost among these were the facts that in the patient's recent relocation, the house in which she was living was in a geographic area with high radon levels but did not contain radon sensors. At the same time, the patient was noncompliant with prior Radiation Checklist efforts and was not participating in ongoing radiation measurements; due to combination of noncompliance, lack of supporting sensor 23 technology, and disinterest in computers. As a result, the consultant counseled the patient as to the importance of radiation safety (which was especially important in light of her relatively high genetic susceptibility and cumulative history of numerous imaging studies using ionizing radiation), and recommended implementation of subcutaneous radiation sensors 23 along with installation of fixed radon sensors 23 in her living space.

21. Additional compliance strategies were implemented by the program 110 to encourage routine compliance with Radiation Checklist requirements, including scheduled weekly telephone reviews of radiation data with the PCP and nurse consultant.

Radiation Therapy for Carcinoma

In this example, a patient with newly diagnosed laryngeal carcinoma presents for therapeutic radiation. Three scenarios are provided to illustrate how medical care and decision making changes in accordance with the data availability and analysis.

A. Scenario 1: Limited Historical Medical Records

1. Patient newly diagnosed with laryngeal (i.e., vocal cord) cancer during the course of laryngoscopy performed for hoarseness.

2. ENT physician consults medical and radiation oncologists for determination of treatment planning.

3. At the time of consultation, the radiation oncologist is presented by the program 110 with the operative note, pathology report, and medical records of the patient for the past 10 years. Medical data prior to that time is not available due to combined factors of changes in medical information technology (i.e., computerization of medical records), destruction of old paper records, and geographic change of the patient.

4. Based upon review of these medical records, the radiation oncologist sees no unusual or mitigating factors to modify radiation treatment of the diagnosed laryngeal carcinoma

5. After consulting with the medical oncologist, referring ENT surgeon, primary care physician, and the patient (along with their key family members), the patient is scheduled for a “routine” regimen of radiation therapy.

6. During the course of the radiation therapy, a few commonly experienced complications are encountered (e.g., skin burn, nausea) which are empirically treated. In addition, the patient is found to develop oral candidiasis; which eventually leads to a systemic infection due to immune compromise and delayed treatment.

7. As a result of this systemic infection, the radiation therapy (as well as chemotherapy) is prematurely terminated and the patient is hospitalized, in order to provide continuous antibiotic therapy under the direction of an infectious disease specialist.

8. After a rigorous 4 week course of intravenous antibiotics, the systemic fungal infection is successfully treated, but the patient experiences deterioration in renal function to the nephrotoxicity (which is a well-documented complication of the antibiotic used for fungal therapy).

9. The patient's oncologic treatment regimen (both chemotherapy and radiation therapy) has to be modified (i.e., reduced in magnitude and duration) in keeping with the impaired immune status and renal function. As a result, the treatment efficacy is reduced and the malignancy worsens.

10. It is determined that palliative care is the only reliable option and the patient ultimately succumbs to the laryngeal cancer within 2 years of the original diagnosis. Since there was no determined breach in the “standard of care”, no adverse medico-legal outcome was experienced.

B. Scenario 2: Complete Medical Records

1. Patient newly diagnosed with laryngeal (i.e., vocal cord) cancer during the course of laryngoscopy performed for hoarseness.

2. ENT physician consults medical and radiation oncologists for determination of treatment planning.

3. At the time of consultation, the radiation oncologist is presented by the program 110 with the operative note, pathology report, and all relevant medical records of the patient going back to childhood.

4. Based upon review of these medical records by the radiation oncologist, it is learned that the patient had a previous history of neck radiation therapy as a child for the treatment of tonsillitis. Additional analysis of the patient's medical records by the program 110 and the radiation oncologist, reveal a mildly reduced immune status (related to longstanding diabetes).

5. After combined consultation with the oncology team, it was determined that the patient was in a “high risk” category, which warranted referral to a more specialized (i.e., tertiary) radiation therapy facility.

6. A modified radiation therapy plan was implemented by the program 110 and the oncology team, to address these risk factors consisting of intensity modulated radiation therapy, which took advantage of state of the art technology which was not available at the original institution.

7. The short term course of radiation therapy included expected short term complications (e.g., mucositis, dry mouth); which were empirically treated in a routine fashion.

8. Long-term, the patient experienced hypothyroidism, resulting in a number of temporary medical problems (e.g., hair loss, fatigue) which were successfully treated with hormonal replacement therapy.

9. The short term effect of treatment was positive with initial tumor regression. Unfortunately, the patient did experience tumor growth over time (1½ years after treatment).

10. Due to the cumulative effect of childhood and adult radiation therapy, no additional radiation therapy could be offered (out of concerns for serious complication such as radionecrosis of the jaw). The patient eventually died, but was able to have 2 additional years of “high quality” life after the original diagnosis.

C. Scenario 3: Complete Medical Records Along with Radiation Profile and Analyses

1. Patient newly diagnosed with laryngeal (i.e., vocal cord) cancer during the course of laryngoscopy performed for hoarseness.

2. ENT physician consults medical and radiation oncologists for determination of treatment planning.

3. At the time of consultation, the radiation oncologist is presented by the program 110 with the operative note, pathology report, and all relevant medical records of the patient going back to childhood.

4. An additional resource made available to the radiation oncologist (and entire oncology planning team) was the patient Radiation Profile and derived analyses by the program 110. This data provided the treatment planning team with the following data:

a. Cumulative whole body radiation dose exposure estimates over the lifetime of the patient in relation to medical treatment and diagnostic procedures.

b. Fractionated organ-specific radiation dose estimates based upon this radiation data.

c. Ancillary radiation dose exposure data based upon actual and estimated non-medical radiation measures (e.g., environmental, occupational).

d. Combined whole body and organ-specific radiation dose estimates for medical and non-medical radiation exposures over the lifetime of the patient.

e. Derived whole body and organ-specific calculations of radiation-induced risk; taking into account cumulative radiation dose, exposure duration, patient age at time of radiation exposures, organ-specific radiation sensitivity, and confounding medical variables.

f. Review of radiation-related medical complications for patients with similar Radiation Profiles from the comprehensive Radiation Profile databases.

g. Predictors of tumor responsiveness from combined review of radiation therapy and radiation profile databases. (This effectively creates a data-driven methodology for predicting radiation responsiveness of a given cancer relative to cancer genetics, a patient's individual profile, and the specific radiation protocol and technology used.)

h. Overall treatment efficacy based upon tumor characteristics, patient profile, treatment protocol, technology used, and individual/institutional providers.

i. Statistical estimates of radiation-induced (organ specific) complications based upon patient Radiation Profile and tumor characteristics.

j. Recommended educational and consultative resources for improved patient compliance and treatment outcome based upon patient Radiation Profile and tumor characteristics.

k. Identification of optimal of preventative treatment planning and prophylaxis based upon tumor characteristics, protocol to be used, and patient Radiation Profile.

5. Based upon this patient and tumor-specific data analysis, a refined treatment planning model was created by the program 110 based upon analysis of data of the specific patient, patients with similar profile characteristics, tumor properties, available technology, and individual/institutional provider characteristics.

6. A number of additional provider consultations and preventative measures were derived based upon these analyses, which included the following:

a. Dietary consultation (address radiation induced complications (e.g., stomatitis, nausea) and optimize diet in keeping with patient preferences and resources.

b. Dental consultation (removal of damaged teeth and treatment of caries prior to radiation to reduce risk of osteonecrosis, optimize oral hygiene).

c. Nurse educator consultation (assist in identification and understanding of radiation related effects and complications, preventive treatment measures, assist in smoking cessation efforts).

d. Endocrinologist consultation (assess risk of radiation-induced complications related to salivary and thyroid gland function and direct preventative and treatment strategies).

e. Speech pathologist (prophylactic speech and swallowing therapy).

7. Based upon these analyses and interventions, a refined treatment planning regimen was introduced by the program 110 aimed at establishing the most effective protocol based upon tumor and patient profiles.

8. This consultative team approach assisted in early identification and treatment of complications, along with targeted education and consultation.

9. The resulting patient, provider, and treatment-derived data was in turn automatically recorded by the program 110 in the Radiation Profile databases 113, 114 for future analyses and establishment of patient and tumor-specific “best practice” guidelines.

Catastrophic Radiation Event

In this example, a catastrophic event (e.g., nuclear plant accident, dirty bomb) has resulted to unexpected high levels of radiation in a local geographic area, with the potential for dissemination based upon wind and water currents. The conventional response calls for an emergency assessment of radiation dose levels, population risk analysis, and containment strategies. This analysis and intervention is largely done on a population level, with minimal regard to individual risk in accordance with historical radiation dose exposures, concomitant health risks, and genetic susceptibility. By using the principles and program 110 of the present invention, the data communication and intervention strategies can be personalized in accordance with individual health risks, while also creating personalized communication and intervention strategies.

Existing Model:

1. Radiation disaster results in high levels of environmental radiation. Upon recognition of the danger, healthcare and law enforcement authorities create an emergency response plan.

2. Based upon measured radiation levels, geography, weather conditions, and population statistics; a “high risk” area is established with emergency medical services provided to all individuals within the encatchment area.

3. Emergent communication efforts are made to notify all persons in the local geographic area of the danger and an advisory made directing them to safety.

4. Medical triage and treatment efforts are focused on individuals in the exposure area with the most obvious and severe medical complications related to high radiation exposures.

5. Environmental radiation levels are continuous measured and simulation models are used to predict radiation spread and dissipation over time. These “high risk’ areas are effectively blocked off restricting inflow, until radiation levels return to baseline.

6. All individuals exposed to high levels of radiation are subjected to continuous monitoring, ongoing treatment, and quarantined from the general population.

7. Clinical follow-up and future medical care is largely directed by maximal exposure levels and acute symptoms related to radiation toxicity.

8. In the event of radiation contamination, involved water supplies are shut down and alternative supplies introduced until radiation levels return to baseline and water testing proves no risk to the general population. (This theme of “risk to the general population” is commonly used in risk assessment, treatment, and interventional strategies for essentially all environmental toxins and infectious agents.)

Revised Model Using the Radiation Profile:

1. Radiation disaster results in high levels of environmental radiation. Upon recognition of the danger, healthcare and law enforcement authorities create an emergency response plan.

2. Based upon measured radiation levels, geography, weather conditions, and population statistics, from program 110 sensors 23 where applicable, a “high risk” area is established with emergency medical services provided to all individuals within the encatchment area.

3. The geographic area of involvement is continuously updated and refined based upon continuous “fixed” and “mobile” measurements. Fixed measurements are provided by stationary sensors 23 while mobile measurements are provided by moving (human) sensors 23. These continuous measurements provide up to date analyses related to the source, magnitude, and directionality of the radiation disaster. This continuous tracking ability of the program 110 can apply to solitary are multiple radiation sources.

4. These actual fixed and mobile radiation measurements are in turn correlated by the program 110 with weather measurements to refine the simulation model for predicting future spread and dissipation.

5. Medical triage and containment efforts are guided by single, group, and large-scale data measurement and analysis by the program 110. This provides a data-driven method for identifying individuals with both the highest exposure level measurements, as well as those individuals at “highest risk” (which is quantified by individual Radiation Profile program 110 analyses).

6. Emergent communication efforts can be directed through both generalized and customized methods, by the program 110. Generalized communication is aimed at reaching large populations and directing them to safety and reducing overall radiation healthcare risk. Customized methods of communication take into account the radiation dose measurements and each individual's unique radiation risk (in accordance with their Radiation Profile). This effectively provides a program 110 communication tool which is specific to both user and location specific.

7. Wireless technologies (e.g., smart phone, laptop computer) can be integrated by the program 110 in this communication strategy and alert system to notify individuals of radiation safety concerns, healthcare risks, treatment options, and intervention strategies (e.g., evacuation route). The ability of the program 110 of the system 100 to synch these portable electronic devices with wearable (or embedded) sensors 23 provides a direct means of correlating individual real-time and location-specific radiation risk with intervention.

8. Medical triage and treatment efforts are directed to both high exposure and high risk individuals within the defined area of risk. An individual who may have only modest levels of recorded radiation exposure may be deemed by the program 110 to be high priority when their Radiation Profile analysis places them at high risk.

9. This Radiation Profile analysis of risk by the program 110 also provides a fundamental tool for allocating medical resources and preventative methods for long term medical care.

10. In the event of radiation contamination, involved water supplies are shut down and alternative supplies introduced until radiation levels return to baseline and water testing proves no risk. Rather than establish fixed general population guidelines, risk is quantified on individual terms, specific to individual Radiation Profile analyses by the program 110. In this example, a decontaminated water supply may be deemed safe for “low Radiation Profile risk individuals”, while still carrying a slightly increased risk for medium and high risk Radiation Profile individuals (who may be instructed to drink bottled water until risk-adjusted water levels are deemed acceptable).

11. All healthcare data is automatically recorded by the program 110 in both patient, local, and regional Radiation Profile databases 113, 114 to facilitate clinical outcome analysis of radiation dose, radiation-induced medical complications, and Radiation Profile risk analysis. The goal is to use this data to establish “best practice” guidelines commensurate with individual Radiation Profile analysis.

Patient Education, Consultation, and Intervention

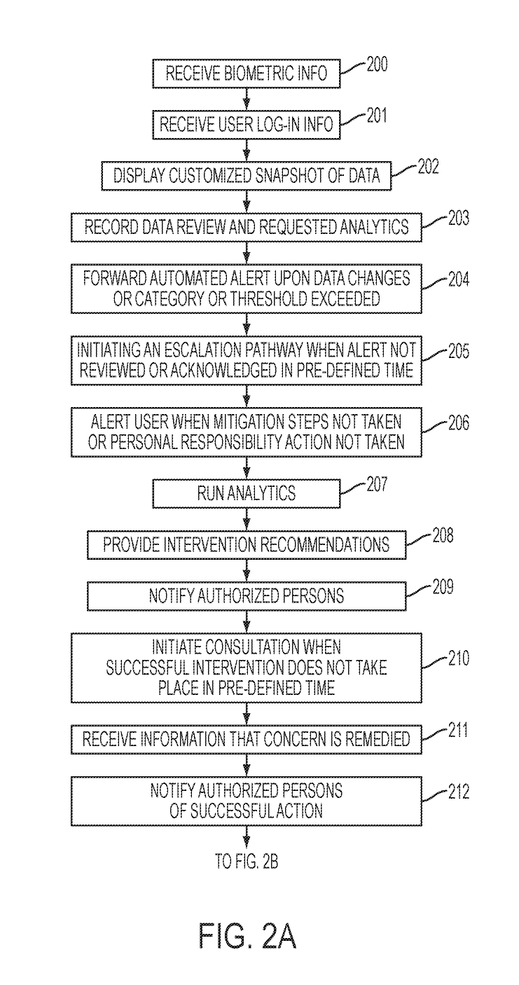

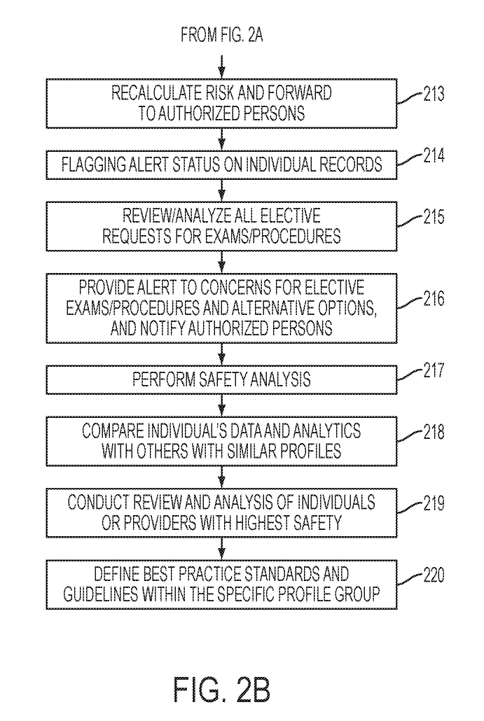

In step 201, patient logs onto personal Radiation Profile database 113, 114 account after biometric authentication in step 200 (see FIG. 2A).

Upon opening the application, the program 110 presents the patient in step 202, with a customized snapshot of data on the display 104, which includes recent radiation data measurements from sensors 23 (mobile or fixed), predefined analytics, trending analysis showing recent changes in radiation risk assessment, and recent data access and/or input by third parties.

Any of these individual applications can be opened and reviewed in greater detail, based upon the patient's interest level. In addition, itemized data and/or analytics can be forwarded to a third party for review and consultation.

Based upon the patient's designed data presentation template, data is presented by the program 110 on the display 104, in a hierarchical fashion, such that higher priority data is color coded to visually highlight significance.

All data review and requested analytics are recorded by the program 110 in step 203, in the Radiation Profile database 113, 114 (e.g., using electronic auditing tools, eye tracking), including recording the specific data reviewed, time spent on each item, requested analytics, consultation requests, and educational programs utilized.

In one scenario, a few days after the last data reviewed, upon data changes received by the program 110, or a category or threshold which is exceeded, the program 110 will forward the patient an automated alert (e.g., via smart phone) in step 204, alerting them to the fact that “high priority” and/or “negatively trending” data was recorded in the Radiation Profile database 113, 114 requiring immediate review and acknowledgement. A secure hyperlink is provided in the alert to the patient by the program 110 for prompt data access and review (which first requires user authentication using biometrics for security).

If acknowledgement and review of this data is not completed within a predefined time (e.g., 6 hours), an escalation pathway is automatically engaged by the program 110 in step 205, which requires a designated person (e.g., primary care physician, designated family member) to formally acknowledge receipt.

In this particular example, a radon detector in the patient's home (i.e., basement) was found to record excessively high radon levels above baseline and a predetermined acceptable threshold.

In this example, the program 110 also provides an alert in step 206 to notify the patient that continuous personal radiation exposure levels have not been recorded over the past 72 hours, suggesting that mitigation steps, or personal responsibility action, such as wearable radiation monitors 23 have not been utilized or data recorded.

The program 110 runs analytics in step 207, and then provides the patient with a number of intervention recommendations in step 208, while also cc′ing a copy of this data to the designated primary healthcare advisor or other authorized persons, for follow-up in step 209.

In this example, the recommended interventions include the following:

a. Immediate testing (and if necessary replacement of home radon detectors).

b. If high radon levels are reproduced, consultation with designated professionals (e.g., physicist, building consultant) to remedy the situation.

c. Automated alert of all healthcare providers to notify them of the recent change in radiation risk status, with recommendations for increased scrutiny on all non-emergent medical procedures/exams.

d. Options for improving compliance for routine daily radiation monitoring (e.g., implantable radiation sensors, change in semi-permanent wearable sensor (e.g., watch).

If successful intervention does not take place within a defined time (commensurate with the level of priority), a formal radiation safety consultation is automatically requested by the program 110 in step 210, for formal review by a specialized team of specialists.

Once the prioritized concern has been successfully remedied the patient (i.e., radon problem resolved, and monitors 23 fixed and sending data under radon danger threshold) in step 211, and the primary care provider or other authorized persons are notified of the successful action in step 212, the program 110 also recalculates and forwards the change to calculated radiation risk in step 213 to authorized persons (see FIG. 2B). (If the patient has an agreement in writing with a healthcare insurer, this party may also be notified of these changes.)

In the event that either the patient has been placed on heightened alert status (due to an increased radiation risk) or requests increased scrutiny, as flagged in the database 113,114 in step 214, the program 110 will proactively review and analyze all elective requests for medical examinations/procedures with ionizing radiation in step 215. This heightened scrutiny can involve a number of different analyses including (but not limited to) the radiation profile of ordering clinicians, protocols employed for the exams in question, radiation profile of the technologist performing the exam, and technology in use.

In the event that a provider, protocol, or technology in use exceeds radiation safety baseline levels (through a radiation database comparative analysis by the program 110 in step 215), the patient is automatically alerted by the program 110 in step 216, to the concern (along with accompanying data), and provided with alternative options of providers, technologies, protocols which have higher radiation safety profiles. These alerts can be programmed to be simultaneously transmitted by the program 110 to designated consultants and/or healthcare providers for review, input, and consultation in the same step.

The derived “radiation savings” of interventions is recorded into the database 113, 114 by the program 110, and used in longitudinal radiation safety analysis in step 217, to quantify the theoretical impact of proactive measures taken by the patient and healthcare providers.

The program 110 will also provide a tool for comparative analysis, in which an individual patient's radiation data and analytics are compared with those of patients with similar radiation profiles in step 218. Those “same profile” patients (or providers) with the highest radiation safety measures and analytics are then highlighted for review and analysis in step 219, to define “best practice” standards and guidelines within a specific profile group in step 220.

The present invention includes the idea that populations, even at group levels, are inherently inhomogeneous in nature, and possess variability which can be quantified and stratified in accordance with a number of standardized variables. Once this profiling system is established, the dynamics of an individual's profile can be used to create a number of healthcare applications aimed at improving clinical outcomes. In addition to personalized monitoring, the derived data by the program 110, can be used to create customizable analytics, which are designed to be of greatest utility to the individual stakeholder based upon their unique profile characteristics and attributes. In addition to these customizable analytics, the program 110 can be used to create a wide array of customizable educational programs, decision support applications, identification of opportunity for technology refinement and new development, clinical and basic science research, and creation of “best practice” standards and guidelines (which are specific to individual stakeholders, as opposed to the conventional “one size fits all” approach).

The present invention is designed to be applicable to the lay population as well as a number of healthcare providers including but not limited to primary care providers, physician consultants, medical physicists, technologists, administrators, information technology specialists, technology producers, and third party payers. Each respective sub-group can utilize the associated databases 113, 114 to proactively assist in healthcare optimization, as well as better understand their own unique opportunities for performance improvement. A number of new and novel methods are described in the patent for monitoring, detection, and quantification of the core data used in the profiling databases 113, 114.

While the primary focus of the invention is on radiation, the same principles and applications described can be used for a number of other types of exposures associated with healthcare risks and complications, many of which are routinely encountered in everyday life but relatively under-reported and quantified.

Lastly, the present invention has important applications for catastrophic events; which can occur naturally, accidentally, or intentionally through acts of terrorism or warfare. The goal is ultimately to create a comprehensive method of prospective detection, monitoring, documentation, analysis, and intervention, which can be customized to the unique attributes, needs, and preferences of different end-users.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of providing a risk assessment, comprising:
receiving data inputted on an individual, said data including at least demographic information on the individual, and saving said data in at least one database of a computer system;
creating a user-specific profile, which classifies the individual into a category commensurate with risk of injury to one of radiation exposure or exposure to at least one of an organic, a pathogenic, or a noxious agent or stimuli;
receiving data from at least one sensor disposed within or on the individual, or disposed in a geographic location, and saving said sensor data in said at least one database;
presenting to the individual, on a display of the computer system, a customized snapshot of data from at least said demographic information, said user-specific profile, and said at least one sensor;
performing analytics using said data from at least said demographic information, said user-specific profile, and said at least one sensor, to assess risk to the individual; and
providing the individual with at least one option for an intervention to mitigate said risk.

2. The method of claim 1, wherein said user-specific profile includes at least one category of classification of the individual based on medical history, user compliance with medical instructions, and educational status;
wherein said medical history includes at least one of an age of a patient, past radiation exposure or agent exposure to said patient, patient genetic make-up, or genetic analysis of a specific pathology of said patient, are incorporated into said user-specific profile, and are used in said analytics to predict relative medical risk or optimize medical treatment planning.

3. The method of claim 1, further comprising:
collecting and monitoring data from said at least sensor, wherein said at least one sensor records data from a radiation source including at least one of occupational, environmental, medical, technologic, criminal, or catastrophic sources of radiation.

4. The method of claim 3, wherein said agent exposure includes exposure to environmental allergens, chemicals, gases, biologic agents, pharmaceuticals, hydrocarbons, industrial solvents, carcinogens, or minerals.

5. The method of claim 4, wherein a combined retrospective and prospective data obtained from at least said medical history, said user-specific profile, and said at least one sensor, are used for said analytics to calculate said risk, and to create a total exposure index and weighted exposure index;
wherein said total exposure index is a cumulative total of all exposure measurements, which is independent of user-specific and context-specific risk factors; and
wherein said weighted exposure index is a measure which combines a totality of exposure measurements with individual risk factors, in order to mathematically predict relative risk over different durations of time and different exposure intensities and distributions.

6. The method of claim 5, wherein said radiation user-specific profile is directed to at least one of a specific individual, an organ system, or a type of pathology.

7. The method of claim 6, wherein said at least one sensor is one of directly embedded into the end-user's body, or into a wearable device of a user, disposed in a stationary measuring device physically positioned in a geographic location, or in a mobile device that moves in a geographic area; and
wherein continuous data is obtained in real-time from said at least one sensor.

8. The method of claim 7, wherein said at least one sensor is a radon sensor, a carbon monoxide sensor, a wind sensor, a radiation sensor, a carcinogenic sensor, a virus or bacterial agent sensor, a GPS sensor, or a heat sensor.

9. The method of claim 8, wherein said real-time continuous data is integrated with a geographic location analysis, to create a three-dimensional (3D) map which plots a concentration and distribution of radiation or agent over time; and
wherein an analysis of said risk exposure specific to the individual is performed, including continuous analysis of data specific to said radiation or agent and said geographic location.

10. The method of claim 9, further comprising:
using said GPS sensor to create a vector analysis of migration, perform customizable context and user-specific risk analyses based upon user-specific profiles, said vector analysis including a least one of providing a nearby safe area, providing directions to said nearby safe area, providing feedback which tracks ongoing measurements as the individual travels through said geographic location, and providing heat maps demonstrating differential levels and associated risk over said geographic location.

11. The method of claim 10, wherein said feedback tracking includes at least one of voice, text or email, including color-coding of navigation routes through said geographic location.

12. The method of claim 11, wherein said at least one sensor is a mobile sensor which is one of a self-propelled motorized device, a drone, a tandem device, a projectile or a propulsion device.

13. The method of claim 12, further comprising:
measuring said agent using said at least one sensor, said agent which is specific to the individual and specific to said geographic location;
combining data measurements from the individual with data recorded by other individuals traveling within said geographic location, and data recorded by sensors disposed in said geographic location;
analyzing said combined data measurements to produce a real-time vector analysis of each said agent, which when combined with external weather conditions including, heat and wind, produces dynamic actual and predictive exposure measurements;
correlating a changing position of the individual and analytics of said user-specific profile, to create a customizable continuous cumulative risk score which can be derived and delivered to the individual in accordance with predetermined communication and educational preferences.

14. The method of claim 13, wherein said continuous cumulative risk score can be classified in accordance with said agent, said organ system, said type of pathology, or said geographic location.

15. The method of claim 13, further comprising:
correlating data from said sensors disposed in said geographic location within close proximity to one another, to ensure that data measurements recorded by said sensors are consistent with one another over time.

16. The method of claim 15, wherein when data changes from said at least one sensor, or said risk assessment exceeds a predetermined threshold or category, at least one of an automated alert or prompt, which requires review and acknowledgement, is sent to at least one of the individual, healthcare providers, law enforcement agencies, or public safety providers.

17. The method of claim 16, wherein real-time exposure data received from said at least one sensor, and projections based upon magnitude, location, and directionality can be customized in accordance with said user-specific profile to provide up-to-minute risk assessment.

18. The method of claim 17, further comprising:
using said user-specific profile data and said analytics to predict future patterns and actions, in accordance with dynamic data measurements and trending analyses, including predicting future radiation dose levels, geographic distribution of radiation, and morbidity or mortality in accordance with local population radiation profiles, and strategies for containment, intervention, and medical treatment, to optimize disaster recovery efforts.

19. The method of claim 1, wherein a quality assurance or quality control program provides routine testing, calibration, and monitoring of data being recorded with said at least one sensor.

20. A system which provides a risk assessment, comprising:
at least one sensor disposed within or on an individual, or disposed in a geographic location, which records data in a database of a computer system;
at least one memory which contains at least one program which comprises the steps of:
receiving data inputted on an individual, said data including at least demographic information on the individual, and saving said data in at least one database of a computer system;
creating a user-specific profile, which classifies the individual into a category commensurate with risk of injury to one of radiation exposure or exposure to at least one of an organic, a pathogenic, or a noxious agent or stimuli;
receiving data from at least one sensor and saving said sensor data in said at least one database;
presenting to the individual, on a display of the computer system, a customized snapshot of data from at least said demographic information, said user-specific profile, and said at least one sensor;
performing analytics using said data from at least said demographic information, said user-specific profile, and said at least one sensor, to assess risk to the individual; and
providing the individual with at least one option for an intervention to mitigate said risk; and
at least one processor for executing said program.

21. A non-transitory computer readable medium whose contents cause a computer system to provide a risk assessment, comprising:
receiving data inputted on an individual, said data including at least demographic information on the individual, and saving said data in at least one database of a computer system;
creating a user-specific profile, which classifies the individual into a category commensurate with risk of injury to one of radiation exposure or exposure to at least one of an organic, a pathogenic, or a noxious agent or stimuli;
receiving data from at least one sensor disposed within or on the individual, or disposed in a geographic location, and saving said sensor data in said at least one database;
presenting to the individual, on a display of the computer system, a customized snapshot of data from at least said demographic information, said user-specific profile, and said at least one sensor;
performing analytics using said data from at least said demographic information, said user-specific profile, and said at least one sensor, to assess risk to the individual; and
providing the individual with at least one option for an intervention to mitigate said risk.
